(19) United States
(12) Patent Application Publication
(10) Pub. No.: US 2012/0005015 A1
(43) Pub. Date: Jan. 5, 2012

(54) METHOD AND APPARATUS FOR MANAGING CONTENT OBTAINED BY COMBINING WORKS AND ADVERTISEMENTS WITH PUBLIC LICENSE

(76) Inventors: Sang-Ho Park, Seoul (KR); Byung-Rack Son, Seoul (KR)

(21) Appl. No.: 13/256,142

(22) PCT Filed: Mar. 5, 2010
(86) PCT No.: PCT/KR10/01382

§ 371 Date: Sep. 12, 2011

(30) Foreign Application Priority Data
Mar. 11, 2009 (KR) 10-2009-0020806

(51) Int. Cl. G06Q 30/00

(52) U.S. Cl. 705/14.46; 705/14.68

(57) ABSTRACT

Provided is a method and apparatus for managing content obtained by combining works and advertisements using a public license. A server computer performs the registration of copyright holder computers and advertiser computers which are connected thereto, the registration of copyright holders and advertisers, and public license agreement, registers the works and advertisement data of the copyright holders and the advertisers in a database, and registers content, which is a combination of the registered work and advertisement, in the database. Then, the server computer performs public license agreement and the copy and distribution of the content, which is the combination of the work and the advertisement registered in the database, classifies information of the exposure or click of the advertisements when the general users access the distributor computer or the server computer storing the content, which is the combination of the work and the advertisement, and use the content, according to an exposure site, each work, and each advertisement, and stores the classified information in the database. The server computer receives advertising costs from each advertiser on the basis of the count information, gives advertising revenue to each copyright holder and each distributor on the basis of the degree of contribution of the copyright holder and the distributor, generates exposure information and calculation information of the works and the advertisements for each of the copyright holder, the advertiser, and the distributor, and provides the generated information. Therefore, the invention performs copyright protection according to public license agreement and monitoring for the use of works, actively opens copyright to reconstruct Web information and improve quality, and provides a new advertisement tool at a low cost and with high efficiency using content, which is a combination of works and advertisements distributed through the entire Web without any restriction.

### BACKGROUND OF THE INVENTION

The present invention relates to a content management method and a content management apparatus.

More particularly, the present invention relates to a method and apparatus for managing content obtained by combining works and advertisements using a public license which performs the registration, use, distribution, transmission, and calculation of the content.

In general, the Internet is an open network that is configured so as to enable anybody to access and use the other party computer, and makes it possible for the users to use various services, such as e-mail and file transmission. For example, the Internet is used to transmit multimedia information as well as basic text information, with the development of a compression technique.

With the increasing use of the Internet at home and abroad, the importance of the Internet rapidly increases as a strategic tool for improving efficiency and productivity in the entire industry, and the Internet continuously creates new business opportunities. In addition, the range of the business is expanded and various business models using the Internet appear.

That is, as an example of the business using the Internet, sites providing various kinds of content, such as an Internet advertisement site, an Internet broadcast site, an on-line game site, an Internet newspaper/magazine site, a search service site, a portal service site, and an e-commerce site, rapidly increase.

For example, the works used on the Internet are classified into personal works which are provided free of charge through service providers, such as portal sites, and CP (Content Provider) works which are pay services provided by the service providers, such as copyright holders. Examples of the personal works include text knowledge information, such as Jisikin, and user created content (UCC) information, such as images or moving pictures, and examples of the CP works include music, movie, and news.

CCL (Creative Commons License) that is being currently used is mainly applied to the personal works. However, the CCL does not actually monitor piracy and is not a profit model. The CCL just makes a defensive and moral request, such as “the prohibition of the correction of content”, “nonprofit”, and “the writing of a copyright holder”. Therefore, a way for the individual copyright holders to make a profit on their works through the Internet is very limited. The copyright holders declaratively provide a standard for opening their works to the public and using the works and warn the illegal use of their works, which is difficult to protect the copyright and make a sufficient profit. Therefore, it is difficult for the copyright holders to obtain a regular income from their works if the copyright holders do not acquire advertisements. In the transaction between the service providers of the CP works, there is a conflict of opinions on ‘profit sharing’, ‘editorial rights’, and ‘traffic paths’.

In addition, with the spread of the Internet, distribution-type advertisements have been developed to various kinds of advertising, such as keyword advertising in which advertisements are posted to the search result according to keywords input by the user and banner advertising in which images or moving pictures are posted to a portion of a Web site to obtain an advertising effect, together with various kinds of works.

For example, Google AdSense distributes only advertisements regardless of works and exposes advertisements from a copyright holder space in response to an advertisement insertion request from the copyright holder. In this case, when the works are copied and distributed, the advertisements do not follow the works and no profit is distributed to the user who redistributes the works. In addition, the distribution of advertising revenue is based on the sum of actions according to requests at the time when the requests for the advertisements are satisfied (page view; PV) or OO won for click×the number of clicks of the correcting copyright holder site).

As described above, the CCL (Creative Commons License) for the works on the Internet according to the related art declaratively provides the minimum principle for the user who uses the works, but does not perform the follow-up control of the works or guarantee profit on the works. Therefore, there is a restriction in increasing the creative wants of the copyright holders. In addition, the users who use the opened works do not actively utilize the copy and reconstruction of the works since the range of copyright is unclear and the users have legal and psychological burdens.

For the advertisement, which is the main source of income of the Internet works, the copyright holder combines his or her own works with self-advertisements and exposes the combination from his or her site, but does not distribute the works combined with the advertisements to the users. In addition, when the copyright hold wants to obtain the advertising revenue of the works, the copyright hold is subjected to the portal service providers since it is difficult to acquire advertisements. As a result, the copyright hold is very disadvantageous in profit sharing.

Therefore, the advertisers who want effective advertisement targeting as well as the copyright holders who want to obtain profit through their works have become increasingly dissatisfied, and it is difficult to achieve the wants of many users who want to construct rich knowledge and information libraries on the Internet.

### SUMMARY OF THE INVENTION

The invention has been made in view of the above-mentioned problems and an object of the invention is to provide a method and apparatus for managing content obtained by combining works and advertisements using a public license in which a server performs the generation and distribution of the content, which is a combination of the works and the advertisements, on the basis of public license agreement with a copyright holder, an advertiser, and a distributor and distributes a portion of the advertising revenue to the copyright holder and the distributor on the basis of advertisement exposure information when general users use the content.

Another object of the invention is to provide a method and apparatus for managing content obtained by combining works and advertisements using a public license that enables advertisers to set information, such as the category, exposure position, and distribution area of works to be combined with advertisements of the advertisers, thereby easily performing target advertisements, and generates a large amount of traffic according to the movement and exposure of the works combined with the advertisements in a wide area, thereby obtaining an advertising effect at a low cost and with high efficiency.

Still another object of the invention is to provide a method and apparatus for managing content obtained by combining works and advertisements using a public license that distributes a portion of the advertising revenue to a copyright holder and a distributor according to the degree of contribution (for example, the number of views or clicks of the general users and the weights of the copyright holder, the distributor, and the works, and a distribution action) of the copyright holder and the distributor for the sum of advertisement costs for each period, in a method of calculating the advertising revenue to be distributed.

Still yet another object of the invention is to provide a method and apparatus for managing content obtained by combining works and advertisements using a public license that prevents an illegal change in the content, which is a combination of the works and the advertisements, and the illegal copy of the content to protect copyright, relieves the burden of the general users on copyright infringement such that the users can actively utilize the works, thereby improving the quality of Web information, and enables the distributors to actively distribute the content, thereby maximizing the exposure of the works and the advertisement.

In order to achieve the objects, according to an aspect of the invention, there is provided a method of managing content obtained by combining a work and an advertisement using a public license. The method includes: (1) a step of allowing a server computer that performs the generation and distribution of the content, which is a combination of the work and the advertisement, the counting of advertisement exposure/click, and calculation on the basis of public license agreement to register a copyright holder of a copyright holder computer which is connected thereto through a communication network, perform the public license agreement with the copyright holder computer, and register works of a copyright holder in a database; (2) a step of allowing the server computer to register an advertiser of an advertiser computer which is connected thereto through the communication network, perform the public license agreement with the advertiser computer, and register advertisement data provided from the advertiser in the database; (3) a step of allowing the server computer to combine each advertisement registered by each advertiser with each work registered in the database in the steps (1) and (2) and register the content, which is the combination of the work and the advertisement, in the database; (4) a step of allowing the server computer to register a distributor of a distributor computer which is connected thereto through the communication network and perform the public license agreement with the distributor and the copy and distribution of the content, which is the combination of the work and the advertisement stored in the database, in response to a request from the distributor; (5) a step of allowing the server computer to count information of the exposure or click of advertisements when general users access the distributor computer or the server computer storing the content, which is the combination of the works and the advertisements, and use the content, classify the count information according to an exposure site, each work, and each advertisement, and store the classified information in the database; and (6) a step of allowing the server computer to receive advertising costs from each advertiser for a predetermined period on the basis of the count information of the exposure or click of the advertisements when the general users use the content stored in the database in the step (5), give advertising revenue to each copyright holder and each distributor on the basis of the degree of contribution of the copyright holder and the distributor including the number of views or clicks of the general users and the weights of the copyright holder, the distributor, work quality, and distribution quality, and generate and provide exposure information and calculation information of the works and the advertisements for each of the copyright holder, the advertiser, and the distributor.

According to another aspect of the invention, there is provided an apparatus for managing content obtained by combining a work and an advertisement using a public license. The apparatus includes: a plurality of copyright holder computers that is connected to a server computer which provides a generation and distribution service of the content, which is a combination of the work and the advertisement, an advertisement exposure/click counting service, and a calculation service on the basis of public license agreement through a communication network, performs the registration of copyright holders, public license agreement, and the registration of works of the copyright holders in a database, and receives calculation information of advertising revenue and exposure information of the works and advertisements from the server computer when general users use the content, which is the combination of the work and the advertisement; a plurality of advertiser computers that is connected to the communication network, performs the registration of advertisers, public license agreement, the registration of the advertisements in the database, and the payment of advertising costs, and receives the exposure information of the works and advertisements from the server computer when the general users use the content, which is the combination of the work and the advertisement; a plurality of distributor computers that is connected to the communication network, performs the registration of distributors, the copy and distribution of the content, which is the combination of the work and the advertisement stored in the database, and public license agreement, and receives the calculation information of the advertising revenue and the exposure information of the works and the advertisements from the server computer when the general users use the content, which is the combination of the work and the advertisement; and the server computer that controls the registration of the copyright holders, the advertisers, and the distributor registers of the copyright holder computers, the advertiser computers, and the distributor computers which are connected thereto through the communication network and public license agreement, controls the registration of the works and the advertisements provided from the copyright holder computers and the advertiser computers in the database, the generation of the content, which is the combination of the works and the advertisements registered in the database, and the copy and distribution of the generated content, accumulates and manages count information of the exposure or click of the advertisements when the general users access the server computer or the distributor computer and use the content, and controls the calculation of advertising costs from each advertiser on the basis of the count information, the calculation of advertising revenue for each of the copyright holders and the distributors on the basis of the degree of contribution of the copyright holders and the distributors, and the generation and provision of the exposure information and calculation information of the works and the advertisements for each of the copyright holders, the advertisers, and the distributors.

As described above, according to the method and apparatus for managing content obtained by combining works and advertisements using a public license, the server computer signs a public license agreement for the use of works, such as the insertion of advertisements and the maintenance of the original form of the works, and the prohibition of a change in the content of the works, and a public license agreement for copyright protection with each of the copyright holders, the advertisers, and the distributors, as the use conditions of the works. Therefore, it is possible to protect the rights of the works and maximize the exposure of the works to obtain advertising revenue, thereby making a profit. In addition, it is possible to change a copyright problem, which is a social problem, from an environment in which copyright is prohibited or regulated to an environment in which copyright is actively allowed and opened. In this way, high-quality knowledge is accumulated and shared by the Internet.

In addition, when content, which is a combination of works and advertisements, is infinitely distributed and used, the burden of the users on copyright infringement is reduced and copyright is actively opened to the public, which leads to a qualitative change in Web information. That is, the Web information based on the persons and position is reclassified according to the property of the works, such as a type and a subject. The distribution of the advertising revenue makes it possible to increase the creative wants and the content utilization and distribution wants of the copyright holders and the distributors, thereby improving the quality of works. In addition, it is possible to prevent the problem of a large amount of low-quality information from being spread through the Internet.

The copyright holders actively open their works, share the works, and obtain a regular income only by signing a public license agreement with the server computer. In addition, it is easy to track the position where the works are copied and a change in the format of the works and protect copyright. The distributors classify the content, which is a combination of works and advertisements, according to the type and subject of the content and distribute the content to the entire Web without any restriction. Therefore, the character of the content user becomes clear and it is easy for the advertiser to determine an advertising target. A large amount of traffic occurs due to a networking effect caused by multi-exposure occurring when the content, which is a combination of works and advertisements, is moved to the entire Web in a wide range, which makes it possible to significantly improve the efficiency of advertising.

### BRIEF DESCRIPTION OF DRAWINGS

FIG. 1 is a block diagram schematically illustrating the structure of an apparatus for managing content obtained by combining works and advertisements using a public license according to the invention.

FIG. 2 is a block diagram illustrating in detail the structure of a server computer shown in FIG. 1.

FIGS. 3 and 4 are diagrams illustrating the generation and distribution of the content, which is a combination of works and advertisements, and a public license according to the invention.

FIG. 5 is a flowchart illustrating in detail the process of a method of managing content obtained by combining works and advertisements using a public license according to the invention.

FIGS. 6 to 8 are flowcharts illustrating in detail the process of each sub-routine shown in FIG. 5.

### DETAILED DESCRIPTION OF THE INVENTION

Hereinafter, a method of managing content obtained by combining a work and an advertisement using a public license and an apparatus for managing the content according to the invention will be described in detail with reference to the accompanying drawings.

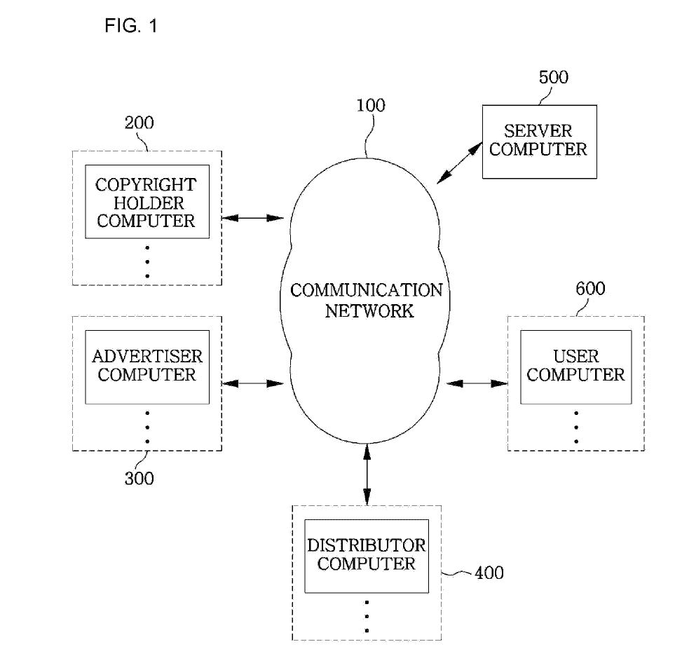

FIG. 1 is a block diagram schematically illustrating the structure of the apparatus for managing content obtained by combining a work and an advertisement using a public license according to the invention.

As shown in FIG. 1, the content management apparatus includes, for example, a communication network (100), copyright holder computers (200), advertiser computers (300), distributor computers (400), a server computer (500), and user computers (600).

The communication network (100) is a communication network, such as the wired or wireless Internet, and connects communication lines among the copyright holder computers (200), the advertiser computers (300), the distributor computers (400), the server computer (500), and the user computers (600), thereby performing data communication related to the generation, distribution, advertisement exposure/click count, and payment of the content obtained by combining a work and an advertisement using the public license.

The copyright holder computer (200) is, for example, a terminal used by a copyright holder, or a blog or a site including works. The copyright holder computer (200) performs communication with the server computer (500) through the communication network (100) by the operation of the copyright holder, and transmits member data (for example, an ID, a password, and personal information) input by the copyright holder to register the copyright holder and selection information related to agreement with the public license to the server computer (500) to register the copyright holder and sign a public license agreement. The copyright holder computer (200) transmits the works of the copyright holder to the server computer (500) to register the works in the database register, and receives the advertising revenue obtained from the general user who uses the content, which is a combination of a work and an advertisement, and the exposure information of works and advertisements from the server computer (500).

In addition, the copyright holder computer (200) downloads a work registration program from the server computer (500) which is registered as a copyright holder by the selection of the copyright holder and installs the program. When the copyright holder executes the work registration program, selects the works, and requests to register the selected works, without communicating with the server computer (500), the copyright holder computer (200) transmits the works selected by the copyright holder to the server computer (500) such that the works can be registered in the database. That is, in addition to the above-mentioned method which directly accesses the server computer (500) and registers the works of the copyright holder, the copyright holder may directly register works in the server computer (500) using the terminal, blog, or site of the copyright holder.

When the copyright holder computer (200) registers works in the server computer (500), the copyholder may select self-advertisement data to be combined with his or her own works (for example, when the copyright holder is a newspaper, news, or a magazine publisher, the copyright holder selects advertisement data for publicizing his or her own company which is to be combined with the works. In this case, the copyright holder pays for the cost of inserting advertisements and managing the works to the server computer (500)). In this case, when the works and the self-advertisement data to be combined with the works are input from the copyright holder computer (200), the server computer (500) registers content, which is a combination of a specific work and the self-advertisement input from the copyright holder computer (200), in the database. The server computer (500) provides, to the copyright holder computer (200), only information related to the advertisements exposed or clicked when the general user uses the content, but does not distribute the advertising revenue.

The advertiser computer (300) is connected to the server computer (500) through the communication network (100) by the operation of the advertiser and transmits, to the server computer (500), member data (for example, an ID, a password, or advertiser information) for registering the advertiser, which is input by the advertiser and selection information for agreement with the public license to register the advertiser and agree with the public license. The advertiser computer (300) transmits the advertisement data of the advertiser to the server computer (500) such that the advertisement data combined with the works is registered in the database. In addition, the advertiser computer (300) calculates advertising revenue obtained from the use of content, which is a combination of works and advertisements, by the general user through a virtual account and receives the exposure information of works/advertisements from the server computer (500).

In this case, the advertiser computer (300) transmits the advertisement data to be registered and targeting information including an advertisement form (a text, an image, or a moving picture), a category, a distribution area, and the unit cost of advertisement input by the advertiser to the server computer (500).

The distributor computer (400) is a terminal used by a general Internet user or a blog or site operator who can copy and distribute content, which is a combination of works and advertisements stored in the server computer (500), on the basis of the public license, without any restriction. The distributor computer (400) is connected to the server computer (500) through the communication network (100) by the operation of a distributor and transmits data (for example, an ID, a password, and personal information) for registering a distributor, which is input by the distributor, to the server computer (500), thereby registering the distributor (when the distributor is registered, the distributor agrees with the public license for copying and distributing content). In addition, the distributor computer (400) browses various kinds of content, which is combination of works and advertisements stored in the server computer (500), requests the server computer (500) to transmit the content, which is a combination of works and advertisements, that is desired to be copied and distributed, copies and distributes the content, which a combinations of works and advertisements, selected by the distributor under the control of the server computer (500) (that is, the distributor shares the content according to the usage provided by the public license). In addition, the distributor computer (400) receives the advertising revenue obtained from the use of content, which is a combination of works and advertisements, by the general user through a virtual account and receives the exposure information of works/advertisements from the server computer (500).

The server computer (500) controls the registration and public license agreement of the copyright holder, the advertiser, and the distributor of the copyright holder computer (200), the advertiser computer (300), and the distributor computer (400) connected to the communication network (100). In addition, the server computer (500) controls the registration of the works and the advertisement respectively provided from the copyright holder computer (200) and the advertiser computer (300) in the database, the generation of contents, which are combinations of the works and the advertisements registered in the database, and the copy and distribution of the generated contents through the distributor computer (400) (the copied and distributed contents are in the desired site of the distributor). The server computer (500) cumulatively manages the count information of the number of clicks or exposure of the advertisement when the user computer (600) connected to the server computer (500) or the distributor computer (400) uses content and controls the calculation of the advertisement cost of each advertiser, the calculation of the advertising revenue of each copyright holder and each distributor based on the degree of contribution of the copyright holder and the distributor, and the generation and provision of the exposure information and calculation information of works/advertisements for each copyright holder, each advertiser, and each distributor, on the basis of the count information.

In this case, when combining the works and the advertisements which have been received from the copyright holder computer (200) and the advertiser computer (300) and then registered, the server computer (500) combines one or more advertisements with each work on the basis of the targeting information requested by the advertiser. When the advertisements suitable for the form and category of works are not registered, the server computer (500) arbitrarily extracts the advertisements registered in the database and combines the extracted advertisements with the works. The server computer (500) displays public license information at a predetermined position in the content, which is a combination of works and advertisements.

In addition, the server computer (500) determines payments (that is, a dividend of the advertising revenue) for each person who is paid the dividend by dividing the sum of the advertising revenue within the period to be divided by a definite amount of money based on the degree of contribution of each person who is paid the dividend (the dividend of the advertising revenue=the sum of the advertising revenue within the period to be divided/the definite amount of money based on the degree of contribution of each person who is paid the dividend). The sum of the advertising revenue within the period to be divided is calculated by subtracting operation and maintenance costs from the sum of the advertisement costs for each type (the sum of the advertising revenue within the period to be divided=the sum of the advertisement costs for each type−operation and maintenance costs). The definite amount of money based on the degree of contribution of each person who is paid the dividend is calculated by multiplying the acquired number of views or clicks, a unit cost, the grades of the copyright holder and the distributor, and work and distribution quality weights (the definite amount of money based on the degree of contribution of each person who is paid the dividend=the acquired number of views or clicks×a unit cost×the grades of the copyright holder and the distributor and work and distribution quality weights). The server computer (500) may simply calculate the definite amount of money of each person who is paid the dividend based on the degree of contribution using “the acquired number of views or clicks×a unit cost”.

That is, in the invention, unlike the advertisement revenue distribution method according to the related art that calculates a unit cost immediately after a click occurs and a payment is distributed only to the distributor (for example, Google) or a distribution assistant (for example, a copyright holder), the sum of the advertisement revenue for a plurality of advertisement forms or the corresponding advertisement form is accumulated for a predetermined period of time, and payments for a plurality of persons who are paid the dividend (the copyright holder and the distributor) are calculated on the basis of the degree of contribution. In this way, the sum of the advertising revenue within a predetermined period, not for each click, is calculated and all persons who participate in making a profit within a predetermined period are paid money according to the degree of contribution to the profit.

The user computer (600) is a terminal, such as a personal computer, a mobile phone, an IPTV, an IP set-top box, or a PDA, which is capable of using the Internet and is used by the user who is not registered as a distributor in the server computer (500). The user computer (600) can browse and use various kinds of content, which is a combination of the works and the advertisements stored in the copyright holder computer (200), the distributor computer (400), and the server computer (500), without any restriction.

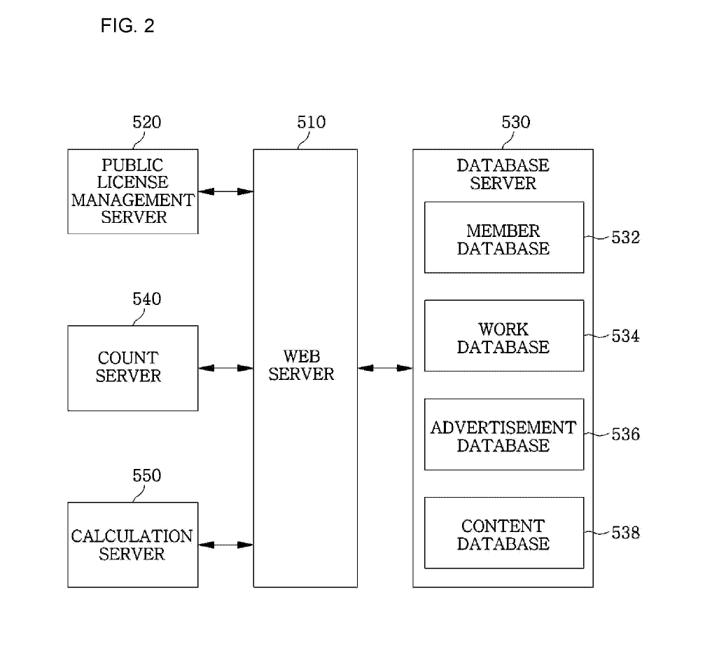

FIG. 2 is a block diagram illustrating in detail the structure of the server computer (500) shown in FIG. 1.

As shown in FIG. 2, the server computer (500) includes a Web server (510), a public license management server (520), a database server (530), a count management server (540), and a calculation management server (550).

The Web server (510) controls the following operations: the communication connection of the copyright holder computer (200), the advertiser computer (300), and distributor computer (400) through the communication network (100); the registration of the copyright holder, the advertiser, and the distributor; the opening of a virtual account; the agreement of a public license; the registration of works and advertisements provided from the copyright holder computer (200) and the advertiser computer (300) in the database; the generation of content, which is a combination of the works and the advertisements; the copy and distribution of the generated content through the distributor computer (400); the accumulation and management of the count information according to the exposure and click of the advertisements when the general user uses the content; the calculation of advertising costs for each advertiser on the basis of the count information; the calculation of advertising revenue for each copyright holder and each distributor on the basis of the count information; and the generation and provision of the exposure information and calculation information of works and advertisements for each copyright holder, each advertiser, and each distributor.

The public license management server (520) manages public license agreement including the prohibition of the change and sale of content, which is a combination of works and advertisements, by the copyright holder computer (200), the advertiser computer (300), and the distributor computer (400) connected thereto through the Web server (510) when the content is used and the prohibition of the copy interruption of content, and manages public license information in the content, which is a combination of works and advertisements.

The database server (530) includes a member database (532) that stores member information of the users who are registered as copyright holders, advertisers, and distributors connected to the Web server (510), a work database(534) that stores works provided by the copyright holders from the copyright holder computer (200), an advertisement database(536) that stores advertisement data provided by the advertisers from the advertiser computer (300), and a content database(538) that stores content, which is a combination of works and advertisements generated by the Web server (510).

The count management server (540) classifies count information related to the exposure or click of the advertisements when the general users access the server computer (500) or the distributor computer (400) and use content, according to each exposure site, each work, and each advertisement, accumulates and manages the count information, and tracks a change in the content, which is a combination of works and advertisements.

The calculation management server (550) calculates advertising costs from each advertiser through the virtual account and advertising revenue for each copyright holder and each distributor on the basis of the count information accumulated and managed by the count management server (540), generates the exposure information and calculation information of the works and advertisements generated for each of the copyright holder, the advertiser, and the distributor for a predetermined period, and transmits the generated exposure information and calculation information to the copyright holder computer (200), the advertiser computer (300), and the distributor computer (400) through the Web server (510).

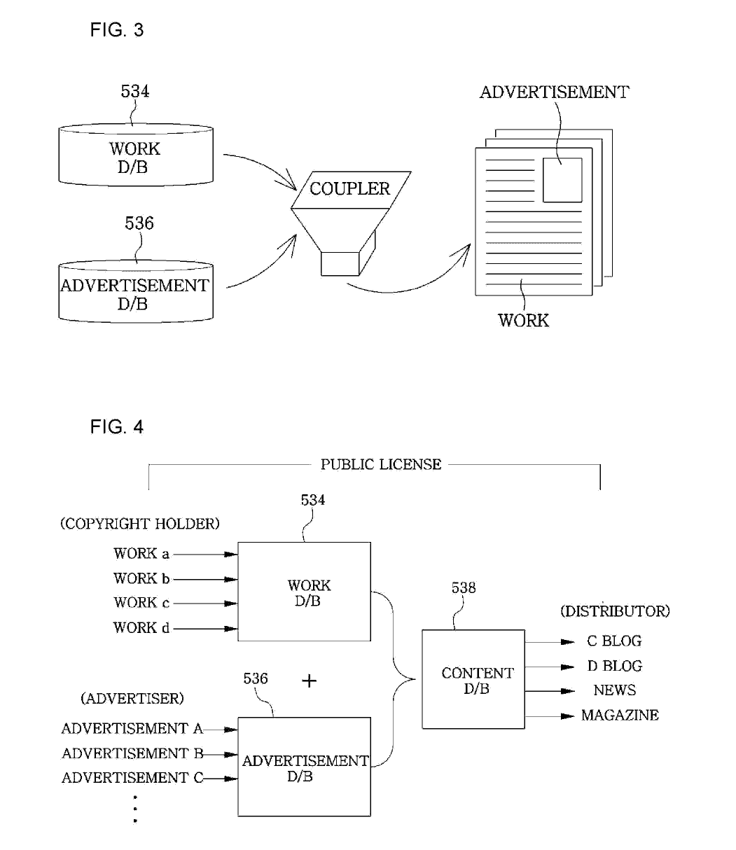

FIGS. 3 and 4 are diagrams illustrating the generation and distribution of the content, which is a combination of works and advertisements, according to the invention and the public license. The server computer (500) combines the advertisements provided by the advertisers with the works provided by the copyright holders to generate content, using a method of automatically inserting scripts using a coupler. When the content is copied and distributed by the distributor who agrees with the public license and is exposed to many users through the Internet, the server computer (500) tracks a change in the content and manages the number of times the content is used.

In this case, the public license between the server computer (500) and each of the copyright holder, the advertiser, and the distributor includes a change prohibition article that prohibits the removal or change of works or advertisements combined with the works, a sale prohibition article that prohibits the sale of works by persons other than the copyright holders and delegates who are allowed to use and distribute the works in the form of an electric document, and a copy interruption prohibition article in which, when works are copied, recopy is prohibited or an apparatus for prohibiting the recopy should not be provided, and public license information needs to be constantly included.

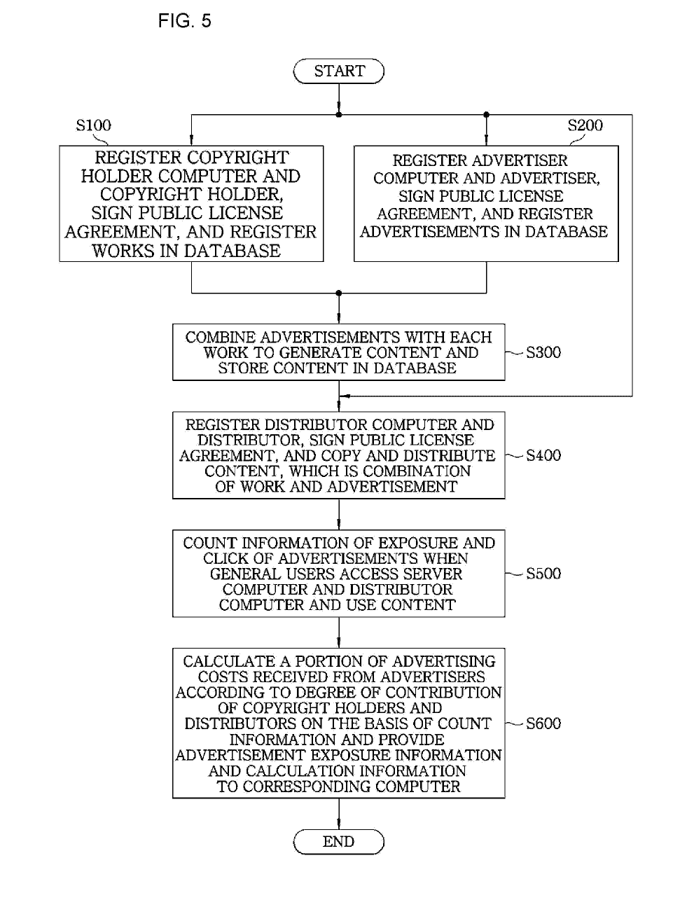

Next, a method of managing the content obtained by combining works and advertisements using the public license according to the embodiment of the invention having the above-mentioned structure will be described in detail with reference to FIGS. 5 to 8.

FIGS. 5 to 8 are flowcharts illustrating in detail processes of the method of managing the content obtained by combining works and advertisements using the public license according to the invention.

First, the server computer (500) that performs the generation and distribution of content, which is a combination of works and advertisement, advertisement exposure/click counting, and the calculation of advertising revenue on the basis of public license agreement registers copyright holders in the copyright holder computer (200) connected thereto through the communication network (100) and performs public license agreement with the copyright holder computer (200). In addition, the server computer (500) registers the works of the copyright holders in the database (S100).

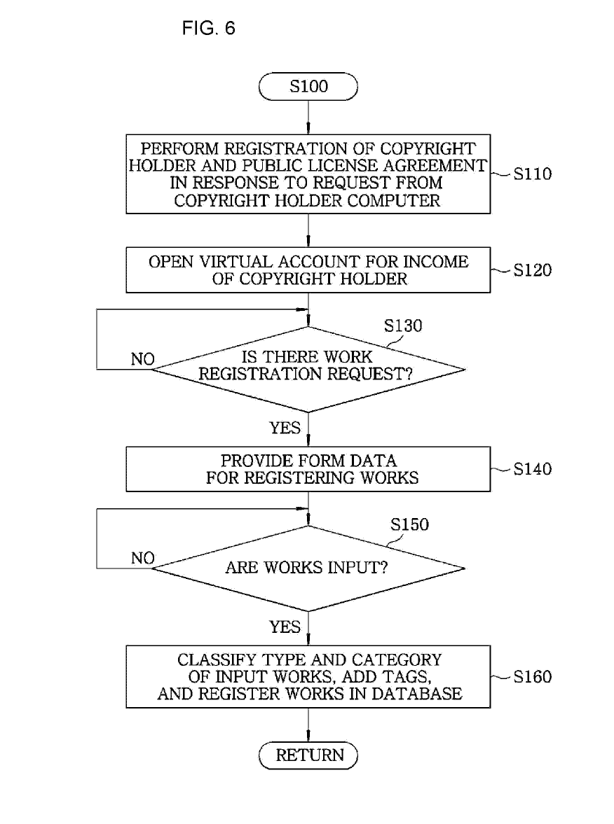

Step S100 will be described in detail with reference to FIG. 6. The server computer (500) requests data required to register the copyright holders and public license agreement in response to a copyright holder registration request from the copyright holder computer (200) connected thereto through the communication network (100), and performs the registration of the holder registers and public license agreement on the basis of member registration data and the selection of the public license input from the copyright holder computer (200) (S110).

After performing the registration of the holder registers and public license agreement, the server computer (500) opens a virtual account for income of the registered copyright holder who agrees with the public license (S120), and determines whether the copyright holder computer (200) that registers the copyright holders and agrees with the public license requests the registration of works (S130).

When it is determined that the copyright holder computer (200) requests the registration of works, the server computer (500) provides predetermined form data for registering works to the copyright holder computer (200) (S140), and determines whether the works to be registered are input from the copyright holder computer (200) on the basis of the form data (S150).

When it is determined that the works to be registered are input from the copyright holder computer (200), the server computer (500) classifies the type (for example, a text, an image, and a moving picture) and category of the works input from the copyright holder computer (200), adds tags to the works, and registers the works in the database (S160).

When the copyright holder downloads a work registration program from the server computer (300), installs and executes the program, selects works to be registered, and requests the registration of the works, without being connected to the server computer (500), the copyright holder computer (200) that is registered as a copyright holder in the server computer (500) in Step S110 may transmit the works to the server computer (500). The server computer (500) may classify the type and category of the works received from the copyright holder computer (200), add tags to the works, and register the works in the database. That is, in addition to the method in which the copyright holder directly accesses the server computer (500) and registers his or her own works therein, a method may be used in which the copyright holder registers his or her own works from a terminal, a blog, or a site to the server computer (500).

The server computer (500) that receives works from the copyright holder computer (200) and registers the works in the database in Step S100 may receive the works and self-advertisement data to be combined with the works from the copyright holder computer (200). When both the works and the self-advertisement data are input, the server computer (500) registers content, which is a combination of a specific work and self-advertisement data input from the copyright holder computer (200). The server computer (500) provides only the advertisements that are exposed or clicked when the general users use the content to the copyright holder computer (200) and may not perform partial distribution of advertising revenue.

The server computer (500) that performs the registration of the copyright holders, public license agreement, and the registration of works in Step S100 performs the registration of advertisers and public license agreement with the advertiser computer (300) which is connected thereto through the communication network (100) and registers advertisement data provided by the advertisers in the database (S200).

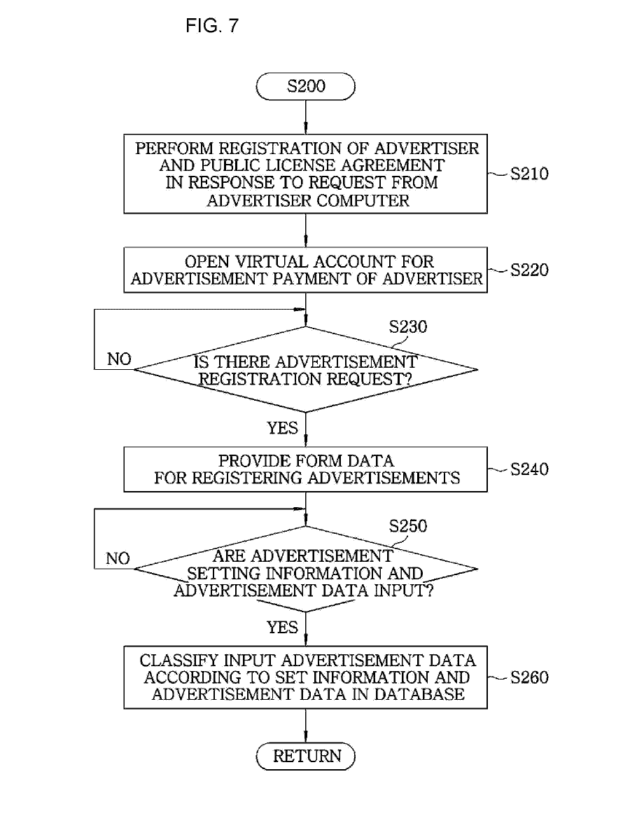

Step S200 will be described in detail with reference to FIG. 7. The server computer (500) requests data required to register the advertisers and public license agreement in response to an advertiser registration request from the advertiser computer (300) connected thereto through the communication network (100), and performs the registration of the advertisers and public license agreement on the basis of member registration data and the selection of the public license input from the advertiser computer (300) (S210).

After performing the registration of the advertisers and public license agreement, the server computer (500) opens a virtual account for advertisement payment of the registered advertiser who agrees with the public license (S220), and determines whether the advertiser computer (300) that registers the advertisers and agrees with the public license requests the registration of advertisements (S230).

When it is determined that the advertiser computer (300) requests the registration of advertisements, the server computer (500) provides predetermined form data for registering advertisements to the advertiser computer (300) (S240), and determines whether targeting information including an advertisement type, a category, a distribution area, the unit cost of advertisement and advertisement data for advertisement registration are input from the advertiser computer (300) (S250).

When it is determined that the targeting information and advertisement data for advertisement registration are input from the advertiser computer (300), the server computer (500) classifies the advertisement data input from the advertiser computer (300) according to the targeting information and registers the classified advertisement data in the database (S260).

The server computer (500) that performs the registration of the copyright holders and the advertisers, public license agreement, and the registration of the works and the advertisements in Steps S100 and S200 step combines the advertisements registered by the advertisers with the works registered in the database to generate content and registers the content in the database (S300).

In this case, when combining the works and the advertisements which are received from the copyright holder computer (200) and the advertiser computer (300) and then registered to generate content in Step S300, the server computer (500) combines one or more advertisements with each work on the basis of the targeting information requested by the advertisers. When the advertisement suitable for the type and category of works is not registered, the server computer (500) arbitrarily extracts the advertisements registered in the database, and combines the extracted advertisements to generate content in which public license information is displayed at a predetermined position.

Then, the server computer (500) that combines each work with each advertisement to generate content and registers the content in the database in Step S300 registers the distributor of the distributor computer (400) which is connected thereto through the communication network (100) and performs public license agreement and the copy and distribution of the content, which is a combination of the works and the advertisements stored in the database, in response to a request from the distributor (S400).

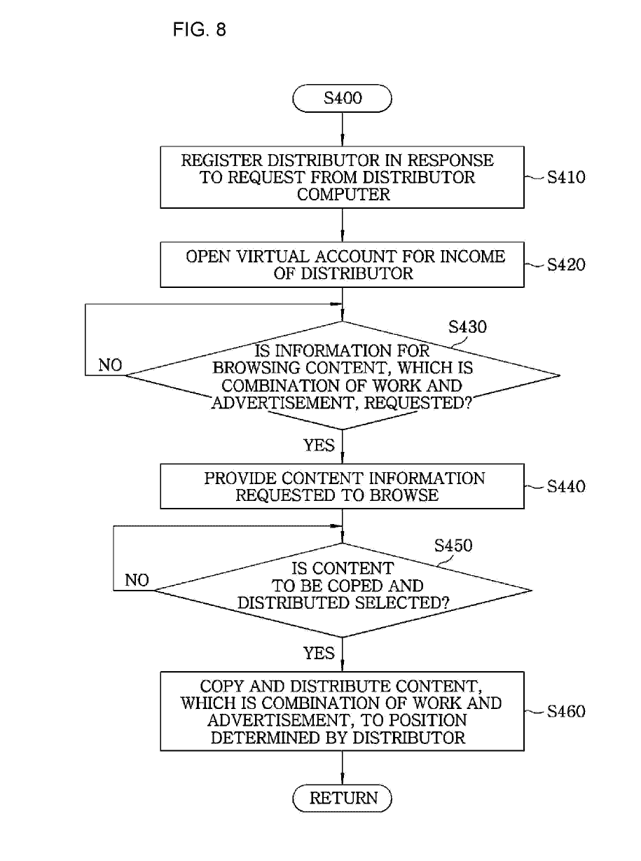

Step S400 will be described in detail with reference to FIG. 8. The server computer (500) requests data required to register the distributor in response to a distributor registration request from the distributor computer (400) which is connected thereto through the communication network (100), and performs the registration of the distributor on the basis of member registration data input from the distributor computer (400) (S410). When the distributor performs distributor registration, the server computer (500) performs public license agreement for the copy and distribution of content.

After registering the distributor, the server computer (500) opens a virtual account for income of the registered distributor (S420) and determines whether the distributor computer (400) that performs distributor registration requests to browse the content, which is a combination of the works and the advertisements stored in the database (S430). In this case, the distributor requests to browse the content using, for example, a category search and a tag and keyword search.

When it is determined that the distributor computer (400) requests to browse the content, the server computer (500) provides the information of the content, which is a combination of the works and the advertisements stored in the database, to the distributor computer (400) (S440).

The server computer (500) determines whether the distributor computer (400) that checks the information of the content, which is a combination of the works and the advertisements selects content to be copied or distributed (S450). When it is determined that the distributor computer (400) selects the content to be copied or distributed, the server computer (500) copies and distributes the content, which is a combination of the works and the advertisements, selected by the distributor to the position requested by the distributor computer (400) and stores the information of the content in the database (S460). In general, the copy and distribution of the content, which is a combination of the works and the advertisements, are performed by the distributor according to the usage defined by the public license agreement which is indicated in the content. When the content is attempted to be copied by another method after being copied and distributed, the mode is changed to a copyright warning and capture prohibition mode.

After copying and distributing the content, which is a combination of the works and the advertisements, in response to the request from the distributor in Step S400, the server computer (500) counts the information of the exposure or click of the advertisements when the general users access the server computer (500) or the distributor computer (400) storing the content, which is a combination of the works and the advertisements, and use the content. Then, the server computer (500) classifies the count information according to an exposure site, each work, and each advertisement and stores the classified information in the database (S500).

Finally, the server computer (500) receives advertising costs from each advertiser on the basis of the count information of the exposure or click of the advertisements when the general users use the content stored in the data base in Step S500 (withdraws the amount of money except for dummies (for example, an irregular income, public benefit, and a test cost) from the count information), collects the advertising costs in a shared account, and gives the advertising revenue determined on the basis of the degree of contribution of the copyright holder and the distributor including the number of views or clicks of the users, the grades of the copyright holder and the distributor, and work and distribution quality weights for a predetermined period (for example, a day, a week, and a month) to each of the copyright holder and the distributor through their virtual accounts. The server computer (500) generates the exposure information and calculation information of the works and the advertisements for each of the copyright holder, the advertiser, and the distributor and provides the generated information to the copyright holder computer (200), the advertiser computer (300), and the distributor computer (400) (S600).

A dividend of the advertising revenue which is distributed to the persons who are paid the dividend (the copyright holder and the distributor) by the server computer (500) in Step S600 is determined by dividing the sum of the advertising revenue within the period to be divided by the definite amount of money based on the degree of contribution of each person who is paid the dividend. The sum of the advertising revenue within the period to be divided is calculated by subtracting operation and maintenance costs from the sum of the advertisement costs for each type. The definite amount of money based on the degree of contribution of each person who is paid the dividend is calculated by multiplying the acquired number of views or clicks, a unit cost, and the grades of the copyright holder and the distributor and work and distribution quality weights. In addition, the definite amount of money based on the degree of contribution of each person who is paid the dividend may be simply calculated by “the acquired number of views or clicks×a unit cost”.

The exemplary embodiments of the invention have been described above, but the invention is not limited thereto. It will be understood by those skilled in the art that various modifications and changes of the invention can be made without departing from the scope and spirit of the appended claims of the invention.

1. A method of managing content obtained by combining a work and an advertisement using a public license, comprising:
(1) a step of allowing a server computer that performs the generation and distribution of the content, which is a combination of the work and the advertisement, the counting of advertisement exposure/click, and calculation on the basis of public license agreement to register a copyright holder of a copyright holder computer which is connected thereto through a communication network, perform the public license agreement with the copyright holder computer, and register works of a copyright holder in a database;
(2) a step of allowing the server computer to register an advertiser of an advertiser computer which is connected thereto through the communication network, perform the public license agreement with the advertiser computer, and register advertisement data provided from the advertiser in the database;
(3) a step of allowing the server computer to combine each advertisement registered by each advertiser with each work registered in the database in the steps (1) and (2) and register the content, which is the combination of the work and the advertisement, in the database;
(4) a step of allowing the server computer to register a distributor of a distributor computer which is connected thereto through the communication network and perform the public license agreement with the distributor and the copy and distribution of the content, which is the combination of the work and the advertisement stored in the database, in response to a request from the distributor;
(5) a step of allowing the server computer to count information of the exposure or click of advertisements when general users access the distributor computer or the server computer storing the content, which is the combination of the works and the advertisements, and use the content, classify the count information according to an exposure site, each work, and each advertisement. and store the classified information in the database; and
(6) a step of allowing the server computer to receive advertising costs from each advertiser for a predetermined period on the basis of the count information of the exposure or click of the advertisements when the general users use the content stored in the database in the step (5), give advertising revenue to each copyright holder and each distributor on the basis of the degree of contribution of the copyright holder and the distributor including the number of views or clicks of the general users and the weights of the copyright holder, the distributor, work quality, and distribution quality, and generate and provide exposure information and calculation information of the works and the advertisements for each of the copyright holder, the advertiser, and the distributor.

2. The method of managing content obtained by combining a work and an advertisement using a public license according to claim 1,
wherein the step (1) includes:
(1-1) a step of allowing the server computer to request data required to register the copyright holder and the public license agreement in response to a copyright holder registration request from the copyright holder computer which is connected thereto through the communication network and perform the registration of the holder register and the public license agreement on the basis of member registration data and the selection of the public license input from the copyright holder computer;
(1-2) a step of allowing the server computer to open a virtual account for income of the copyright holder who is registered and agrees with the public license;
(1-3) a step of allowing the server computer to determine whether the copyright holder computer that performs the registration of the copyright holder and the public license agreement requests the registration of the works;
(1-4) a step of allowing the server computer to provide predetermined data form for registering the works to the copyright holder computer when it is determined that the copyright holder computer requests the registration of the works;
(1-5) a step of allowing the server computer to determine whether the works to be registered are input from the copyright holder computer; and
(1-6) a step of allowing the server computer to classify the type and category of the works input from the copyright holder computer, add tags to the works, and register the works in the database, when the works to be register are input from the copyright holder computer.

3. The method of managing content obtained by combining a work and an advertisement using a public license according to claim 2,
wherein, when the copyright holder downloads a work registration program from the server computer, installs and executes the program, selects the works to be registered, and requests the registration of the works, without being connected to the server computer, the copyright holder computer that is registered as the copyright holder in the server computer (500) in the step (1-1) transmits the works to the server computer, and
the server computer classifies the type and category of the works received from the copyright holder computer, adds tags to the works. and registers the works in the database.

4. The method of managing content obtained by combining a work and an advertisement using a public license according to claim 1,
wherein the server computer that receives the works from the copyright holder computer and registers the works in the database in the step (1) receives the works and self-advertisement data to be combined with the works from the copyright holder computer,
when both the works and the self-advertisement data are input, the server computer registers content, which is a combination of a specific work and the self-advertisement data input from the copyright holder computer in the step (3), in the database, and
the server computer provides only the information of the exposure or click of the advertisements when the general users use the content to the copyright holder computer and does not perform partial distribution of advertising revenue.

5. The method of managing content obtained by combining a work and an advertisement using a public license according to claim 1,
wherein the step (2) includes:
(2-1) a step of allowing the server computer to request data required to register the advertisers and the public license agreement in response to an advertiser registration request from the advertiser computer which is connected thereto through the communication network and perform the registration of the advertisers and the public license agreement on the basis of member registration data and the selection of the public license input from the advertiser computer;
(2-2) a step of allowing the server computer to open a virtual account for advertisement payment of the registered advertiser who agrees with the public license;
(2-3) a step of allowing the server computer to determine whether the advertiser computer that registers the advertiser and agrees with the public license requests the registration of advertisements;
(2-4) a step of allowing the server computer to provide predetermined form data for registering the advertisements to the advertiser computer when it is determined that the advertiser computer requests the registration of the advertisements;
(2-5) a step of allowing the server computer to determine whether targeting information including an advertisement type, a category, a distribution area, the unit cost of advertisement and advertisement data for advertisement registration are input from the advertiser computer; and
(2-6) a step of allowing the server computer to classify the advertisement data input from the advertiser computer according to the targeting information and register the classified advertisement data in the database when the targeting information and the advertisement data for advertisement registration are input from the advertiser computer.

6. The method of managing content obtained by combining a work and an advertisement using a public license according to claim 1,
wherein, when combining the works and the advertisements which are received from the copyright holder computer and the advertiser computer and then registered to generate the content in the step (3), the server computer combines one or more advertisements with each work on the basis of the targeting information requested by the advertiser,
when the advertisement suitable for the type and category of works is not registered, the server computer arbitrarily extracts the advertisements registered in the database and combines the extracted advertisements, and
the server computer generates the content in which public license information is displayed at a predetermined position.

7. The method of managing content obtained by combining a work and an advertisement using a public license according to claim 1,
wherein the step (4) includes:
(4-1) a step of allowing the server computer to request data required to register the distributor in response to a distributor registration request from the distributor computer which is connected thereto through the communication network and perform the registration of the distributor on the basis of member registration data input from the distributor computer;
(4-2) a step of allowing the server computer to open a virtual account for income of the registered distributor;
(4-3) a step of allowing the server computer to determine whether the distributor computer that performs distributor registration requests to browse the content, which is a combination of the works and the advertisements stored in the database;
(4-4) a step of allowing the server computer to provide the requested content information to the distributor computer when it is determined that the distributor computer requests to browse the content;
(4-5) a step of allowing the server computer to determine whether the distributor computer selects the content to be copied or distributed; and
(4-6) a step of allowing the server computer to copy and distribute the content, which is the combination of the works and the advertisements, selected by the distributor to a position requested by the distributor computer and store the information of the content in the database when it is determined that the distributor computer selects the content to be copied or distributed.

8. The method of managing content obtained by combining a work and an advertisement using a public license according to claim 1,
wherein a dividend of the advertising revenue which is distributed to persons who are paid the dividend by the server computer in the step (6) is determined by dividing the sum of the advertising revenue within a period to be divided by a definite amount of money based on the degree of contribution of each person who is paid the dividend,
the sum of the advertising revenue within the period to be divided is calculated by subtracting operation and maintenance costs from the sum of the advertisement costs for each type, and
the definite amount of money based on the degree of contribution of each person who is paid the dividend is calculated by multiplying the acquired number of views or clicks, a unit cost, the grades of the copyright holder and the distributor, and work and distribution quality weights.

9. A recording medium storing a computer program that allows a computer to perform the method according to claim 1.

10. An apparatus for managing content obtained by combining a work and an advertisement using a public license, comprising:
a plurality of copyright holder computers that is connected to a server computer which provides a generation and distribution service of the content, which is a combination of the work and the advertisement, an advertisement exposure/click counting service, and a calculation service on the basis of public license agreement through a communication network, performs the registration of copyright holders, public license agreement, and the registration of works of copyright holders in a database, and receives calculation information of advertising revenue and exposure information of the works and advertisements from the server computer when general users use the content, which is the combination of the work and the advertisement;
a plurality of advertiser computers that is connected to the communication network, performs the registration of advertisers, public license agreement, the registration of the advertisements in the database, and the payment of advertising costs, and receives the exposure information of the works and advertisements from the server computer when the general users use the content, which is the combination of the work and the advertisement;
a plurality of distributor computers that is connected to the communication network, performs the registration of distributors, the copy and distribution of the content, which is the combination of the work and the advertisement stored in the database, and public license agreement, and receives the calculation information of the advertising revenue and the exposure information of the works and advertisements from the server computer when the general users use the content, which is the combination of the work and the advertisement; and
the server computer that controls the registration of the copyright holders, the advertisers, and the distributor registers of the copyright holder computers, the advertiser computers, and the distributor computers which are connected thereto through the communication network and public license agreement, controls the registration of the works and the advertisements provided from the copyright holder computers and the advertiser computers in the database, the generation of the content, which is the combination of the works and the advertisements registered in the database. and the copy and distribution of the generated content, accumulates and manages count information of the exposure or click of the advertisements when the general users access the server computer or the distributor computer and use the content, and controls the calculation of advertising costs from each advertiser on the basis of the count information, the calculation of advertising revenue for each of the copyright holders and the distributors on the basis of the degree of contribution of the copyright holders and the distributors, and the generation and provision of the exposure information and calculation information of the works and the advertisements for each of the copyright holders, the advertisers, and the distributors.

11. The apparatus for managing content obtained by combining a work and an advertisement using a public license according to claim 10.
wherein the server computer includes:
a Web server that controls the communication connection of the copyright holder computers, the advertiser computers, and the distributor computers through the communication network, the registration of the copyright holders, the advertisers, and the distributors, the opening of the virtual account, the public license agreement. the registrations of the works and the advertisements provided from the copyright holder computers and the advertiser computers in the database, the generation of the content, which is the combination of each work and each advertisement, the copy and distribution of the generated content through the distributor computers, the cumulative management of the count information of the exposure or click of the advertisements when the general users use the content, the calculation of the advertising costs from each advertiser and the advertising revenue for each of the copyright holders and the distributors on the basis of the count information, and the generation and provision of the exposure information and calculation information of the works and the advertisements for each of the copyright holders, the advertisers, and the distributors;
a public license management server that manages the public license agreement including the prohibition of a change in the content, the prohibition of the sale of the content, and the prohibition of the copy interruption of the content with the copyright holder computers, the advertiser computers, and the distributor computers which are connected thereto through the Web server when the content, which is the combination of the works and the advertisement, is used and the registration of public license information in the content, which is the combination of the works and the advertisement;
a database server including a member database that stores the membership information of users who are registered as the copyright holders, the advertisers, and the distributors which are connected through the Web server, a work database that stores the works provided by the copyright holders from the copyright holder computers, an advertisement database that stores advertisement data provided by the advertisers from the advertiser computers, and a content database that stores the content, which is the combination of the works and the advertisements generated by the Web server;
a count management server that classifies the count information of the exposure or click of the advertisements when the general user access the server computer and the distributor computer and use the content according to an exposure site, each work, and each advertisement, cumulatively manages the classified count information, and tracks a change in the content, which is the combination of the works and the advertisements; and
a management server that calculates the advertising costs from each advertiser through the virtual account and the advertising revenue for each of the copyright holders and the distributors on the basis of the count information which is cumulatively managed by the count management server, generates the exposure information and calculation information of the works and the advertisements generated for a predetermined period for each of the copyright holders, the advertisers, and the distributors, and transmits the generated exposure information and calculation information to the copyright holder computers, the advertiser computers, and the distributor computers through the Web server.

12. The apparatus for managing content obtained by combining a work and an advertisement using a public license according to claim 10,
wherein the copyright holder computer downloads a work registration program from the server computer which is registered as the copyright holder according to the selection of the copyright holder and installs the work registration program, and
when the copyright holder executes the work registration program, selects his or her own works. and requests the registration of the works. without being connected to the server computer, the copyright holder computer transmits the works selected by the copyright holder to the server computer such that the works are registered in the database.

13. The apparatus for managing content obtained by combining a work and an advertisement using a public license according to claim 10,
wherein, when the works and self-advertisement data to be combined with the works are input, the server computer registers content, which is a combination of a specific work and the self-advertisement data input from the copyright holder computer, in the database, and
the server computer provides only the information of the exposure or click of the advertisements when the general users use the content to the copyright holder computer and does not perform a partial distribution of the advertising revenue.

14. The apparatus for managing content obtained by combining a work and an advertisement using a public license according to claim 10,
wherein, when combining the works and the advertisements which are received from the copyright holder computers and the advertiser computers and then registered, the server computer combines one or more advertisements with each work on the basis of the targeting information requested by the advertisers,
when the advertisement suitable for the type and category of works is not registered, the server computer arbitrarily extracts the advertisements registered in the database and combines the extracted advertisements, and
the server computer displays public license information at a predetermined position in the content, which is the combination of the works and the advertisements.

15. The apparatus for managing content obtained by combining a work and an advertisement using a public license according to claim 10,
wherein the server computer determines a dividend of the advertising revenue which is distributed to persons who are paid the dividend by dividing the sum of the advertising revenue within a period to be divided by a definite amount of money based on the degree of contribution of each person who is paid the dividend,
the sum of the advertising revenue within the period to be divided is calculated by subtracting operation and maintenance costs from the sum of the advertisement costs for each type, and
the definite amount of money based on the degree of contribution of each person who is paid the dividend is calculated by multiplying the acquired number of views or clicks, a unit cost, the grades of the copyright holder and the distributor, and work and distribution quality weights.
